(19) United States
(12) Patent Application Publication
(10) Pub. No.: US 2023/0315527 A1
(43) Pub. Date: Oct. 5, 2023

(54) Robustness Metric for Cloud Providers

(71) Applicant: Google LLC, Mountain View, CA (US)

(72) Inventors: Krzysztof Duleba, Mountain View, CA (US); John Heizelman, Mountain View, CA (US)

(73) Assignee: Google LLC, Mountain View, CA (US)

(21) Appl. No.: 17/657,317

(22) Filed: Mar. 30, 2022

(51) Int. Cl. G06F 9/50; G06F 9/455

(52) U.S. Cl. CPC G06F 9/5033; G06F 9/45533

(57) ABSTRACT

A method includes receiving a system independence query requesting determination of a level of independence between a first system and a second system. The method includes obtaining a first set of time-series data including a first series of data points listed in time order and obtaining a second set of time-series data including a second series of data points listed in time order. Each data point of the first and second series of data points represents a respective system value of a feature associated with the first and second system. The method includes determining an amount of correlation between the first set of time-series data and the second set of time-series data. When the amount of correlation between the first set of time-series data and the second set of time-series data satisfies a correlation threshold, the method includes reporting that the first system and the second system are independent.

### TECHNICAL FIELD

This disclosure relates to a robustness metric for cloud providers.

### BACKGROUND

Distributed computing networks (i.e., “cloud computing”) are increasingly popular due to price, scalability, and flexibility. These computing networks allow users to leverage immense amounts of computing and storage. The computing networks can also offer many other benefits, such as redundancy and reliability across a large number of scenarios. For example, different portions of the computing network can be located in different geographical regions to increase independence from potential failures (e.g., natural disasters).

### SUMMARY

One aspect of the disclosure provides a computer-implemented method for determining an independence of systems that when executed by data processing hardware causes the data processing hardware to perform operations. The operations include receiving a system independence query requesting the data processing hardware to determine a level of independence between a first system and a second system. The operations also include obtaining a first set of time-series data including a first series of data points listed in time order. Each data point of the first series of data points represents a respective first system value of a feature associated with the first system. The operations also include obtaining a second set of time-series data including a second series of data points listed in time order. Each data point of the second series of data points represents a respective second system value of the feature associated with the second system. The operations include determining an amount of correlation between the first set of time-series data and the second set of time-series data and, when the amount of correlation between the first set of time-series data and the second set of time-series data satisfies a correlation threshold, reporting that the first system and the second system are independent.

Implementations of the disclosure may include one or more of the following optional features. In some implementations, the respective first system value of each data point of the first series of data points includes a first system latency value for providing a first resource of the first system and the respective second system value of each data point of the second series of data points includes a second system latency value for providing a second resource of the second system. In these implementations, the first resource may include virtual machines executing within the first system and the second resource may include virtual machines executing within the second system.

In some examples, the first system is located within a first geographical region and the second system is located within a second geographical region. Optionally, determining the amount of correlation between the first set of time-series data and the second set of time-series data includes normalizing the first set of time-series data and the second set of time-series data.

In some examples, determining the amount of correlation between the first set of time-series data and the second set of time-series data includes decomposing the first set of time-series data into a first plurality of components, decomposing the second set of time-series data into a second plurality of components, and comparing a first component of the first plurality of components with a second component of the second plurality of the components. In these examples, the first component may include a noise component of the first set of time-series data and the second component may include the noise component of the second set of time-series data.

In some implementations, the first system is part of a cloud computing service and the second system is part of the cloud computing service. In some examples, determining the amount of correlation between the first set of time-series data and the second set of time-series data includes determining a correlation coefficient for each pair of data points of the first series of data points and the second series of data points. In these examples, determining the amount of correlation between the first set of time-series data and the second set of time-series data further includes creating, using the correlation coefficient of each pair of data points of the first series of data points and the second series of data points, a correlation matrix and averaging a portion of the correlation coefficients of the correlation matrix.

Another aspect of the disclosure provides a system for determining an independence of systems. The system includes data processing hardware and memory hardware in communication with the data processing hardware. The memory hardware stores instructions that when executed on the data processing hardware cause the data processing hardware to perform operations. The operations include receiving a system independence query requesting the data processing hardware to determine a level of independence between a first system and a second system. The operations also include obtaining a first set of time-series data including a first series of data points listed in time order. Each data point of the first series of data points represents a respective first system value of a feature associated with the first system. The operations also include obtaining a second set of time-series data including a second series of data points listed in time order. Each data point of the second series of data points represents a respective second system value of the feature associated with the second system. The operations include determining an amount of correlation between the first set of time-series data and the second set of time-series data and, when the amount of correlation between the first set of time-series data and the second set of time-series data satisfies a correlation threshold, reporting that the first system and the second system are independent.

This aspect may include one or more of the following optional features. In some implementations, the respective first system value of each data point of the first series of data points includes a first system latency value for providing a first resource of the first system and the respective second system value of each data point of the second series of data points includes a second system latency value for providing a second resource of the second system. In these implementations, the first resource may include virtual machines executing within the first system and the second resource may include virtual machines executing within the second system.

In some examples, the first system is located within a first geographical region and the second system is located within a second geographical region. Optionally, determining the amount of correlation between the first set of time-series data and the second set of time-series data includes normalizing the first set of time-series data and the second set of time-series data.

In some examples, determining the amount of correlation between the first set of time-series data and the second set of time-series data includes decomposing the first set of time-series data into a first plurality of components, decomposing the second set of time-series data into a second plurality of components, and comparing a first component of the first plurality of components with a second component of the second plurality of the components. In these examples, the first component may include a noise component of the first set of time-series data and the second component may include the noise component of the second set of time-series data.

In some implementations, the first system is part of a cloud computing service and the second system is part of the cloud computing service. In some examples, determining the amount of correlation between the first set of time-series data and the second set of time-series data includes determining a correlation coefficient for each pair of data points of the first series of data points and the second series of data points. In these examples, determining the amount of correlation between the first set of time-series data and the second set of time-series data further includes creating, using the correlation coefficient of each pair of data points of the first series of data points and the second series of data points, a correlation matrix and averaging a portion of the correlation coefficients of the correlation matrix.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for determining independence of systems.

FIG. 2 is a schematic view of exemplary components of the system of FIG. 1.

FIG. 3A is a schematic view plotting data points of two sets of time-series data.

FIG. 38 is a schematic view plotting an amount of correlation of the two sets of time-series data of FIG. 3A.

FIG. 4 a flowchart of an example arrangement of operations for a method of determining independence of systems.

FIG. 5 is a schematic view of an example computing device that may be used to implement the systems and methods described herein.

Like reference symbols in the various drawings indicate like elements.

### DETAILED DESCRIPTION

A prime capability of distributed computing networks (i.e., “cloud computing”) is reliability (i.e., uptime) even in the face of significant disruptions such as geopolitical events, natural disasters, and/or hardware; software failures. For example, with proper design and placement, a failure of one datacenter has no bearing on the functioning of other datacenters. This allows users of the distributing computing network to achieve fault tolerance by, for example, deploying software across multiple different geographical regions.

In practice, datacenters are rarely fully independent. For example, regional outages are often correlated across different datacenters. Conventional techniques for addressing datacenter dependence rely on reactive responses (i.e., after a failure has occurred, exposing the dependence). Such a reactive response is insufficient as it occurs after the user has potentially experienced an outage. Thus, it is advantageous to determine a level of independence of different portions (e.g., geographically separated) of a distributed computing network that is proactive instead of reactive.

Implementations herein are directed toward an independence evaluator for evaluating an independence between different computing systems (e.g., different distributed computing networks or different portions of the same distributed computing network). The independence evaluator obtains a first set of time-series data representing values (e.g., latencies of requests) of a first system and a second set of time-series data representing the values of a second system. The independence evaluator determines an amount of correlation between the first set of time-series data and the second set of time-series data. Based on the amount of correlation between the first set of time-series data and the second set of time-series data (e.g., when the amount of correlation exceeds a correlation threshold), the independent evaluator reports a level of independence of the first system and the second system.

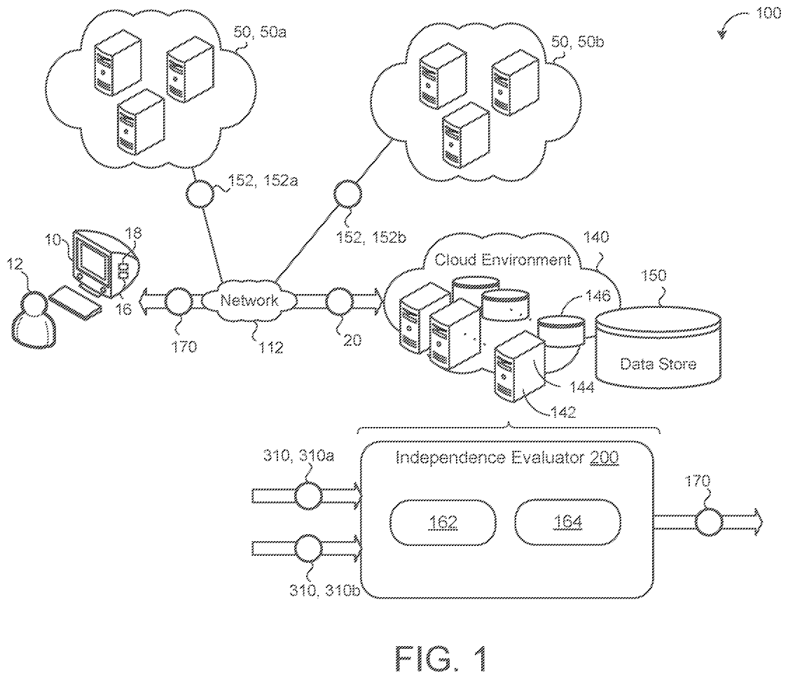

Referring to FIG. 1, in some implementations, an example computing independence evaluation system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g, data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144.

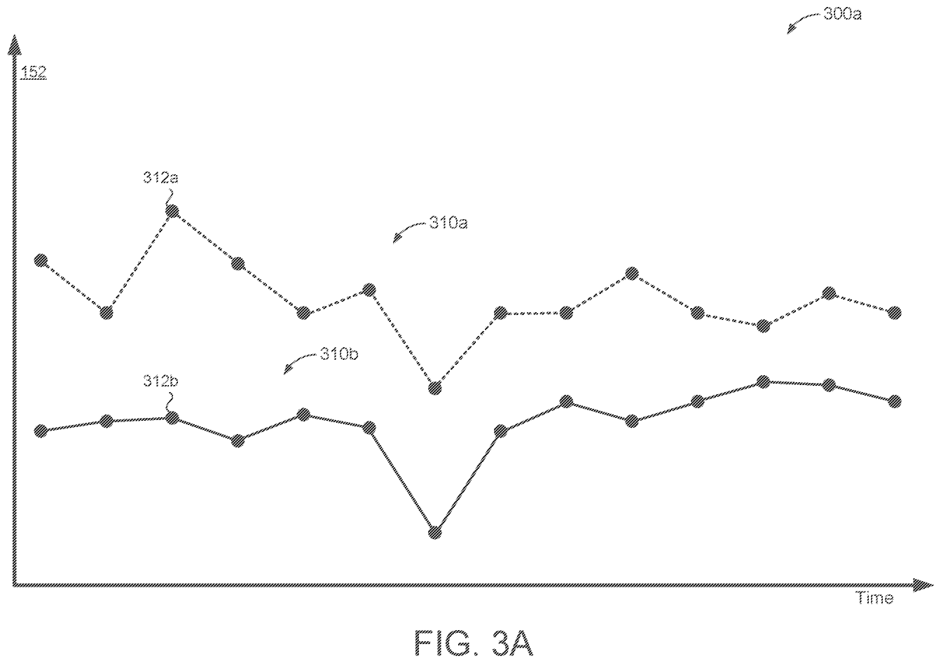

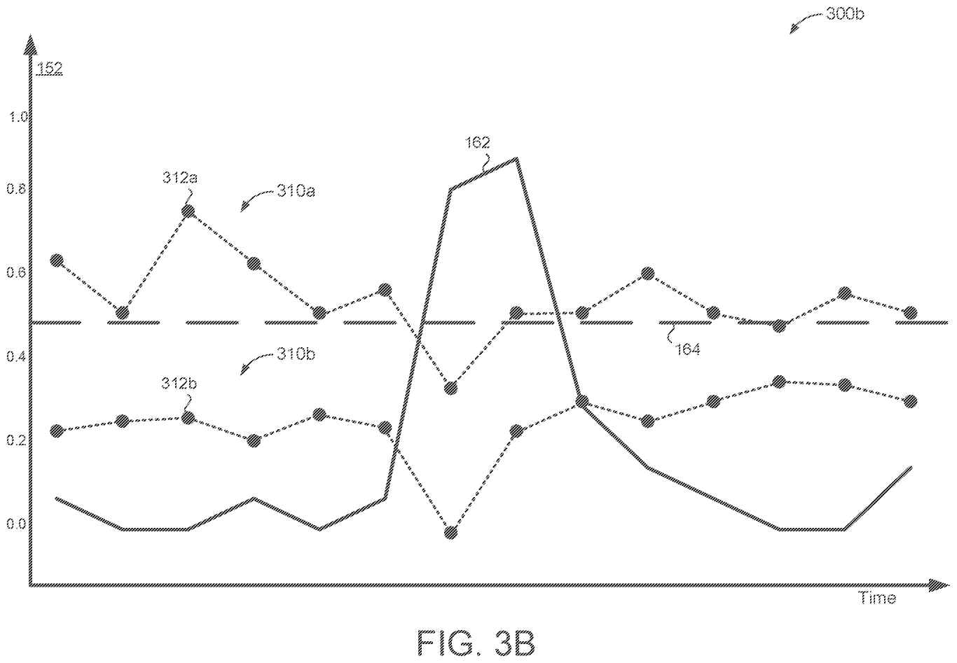

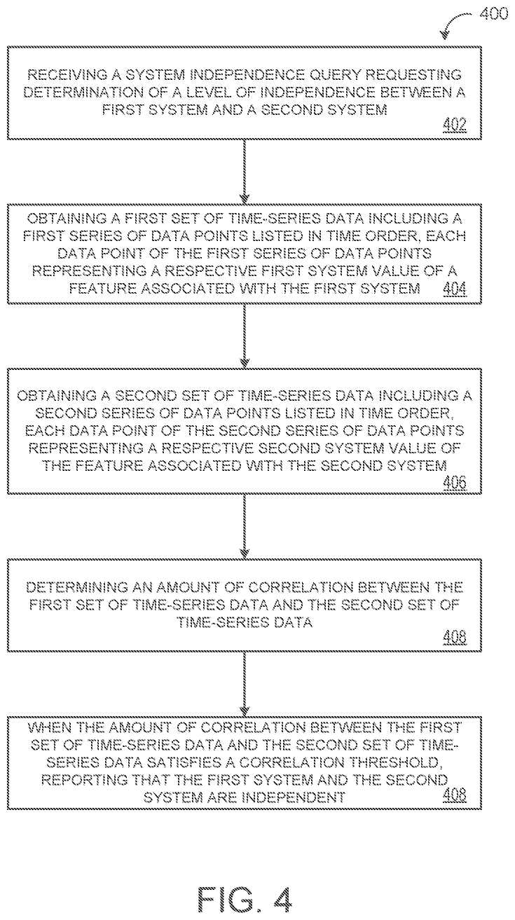

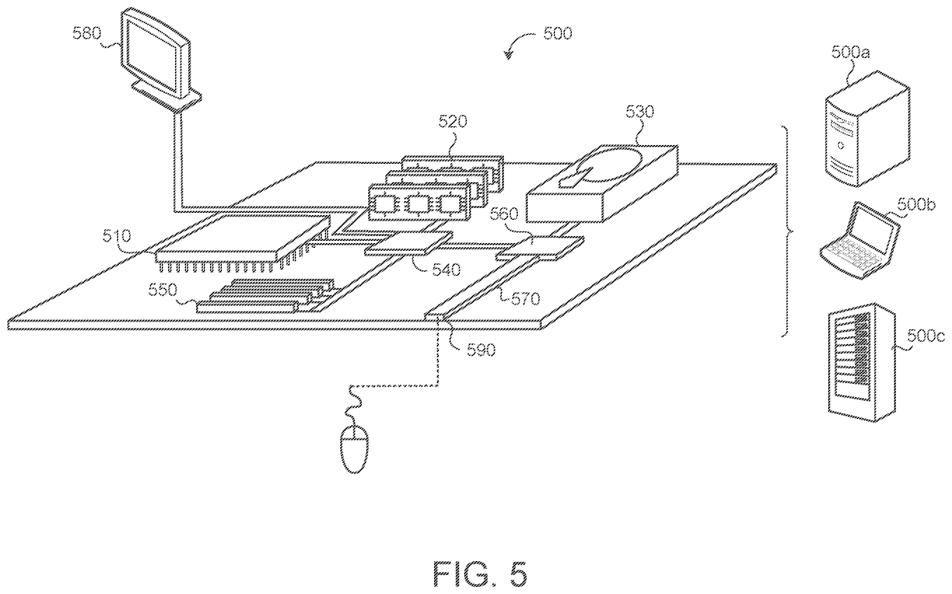

The remote system 140 is configured to receive an independence query 20 from, for example, a user device 10 associated with a respective user 12 (e.g., via the network 112). The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The independence query 20 requests for the remote system 140 to generate an evaluation of an amount of correlation 162 between a first system 50, 50a and a second system 50, 50b based on a first set of time-series data 310, 310a and a second set of time-series data 310, 310b. The amount of correlation 162 between the systems 50 represents an amount of dependences between the systems 50, i.e., a likelihood that a failure in one system 50 will affect the other system 50. For example, with highly dependent systems 50, a failure in one system 50 has a significant chance at causing a failure (e.g., an outage) in the other system 50. On the other hand, two systems 50 with a high amount of independence are less likely to have failures affect each one simultaneously. Each set of time-series data 310 includes a series of data points 310 (FIG. 3) listed in time order.

The first system 50a and the second system 50b represent any number of computing or networking devices (e.g., servers, virtual machines, routers, switches, etc.). In some examples, the first system 50a is a part or portion of the remote system 140 (e.g., a portion of a cloud computing service) located in a first geographical area or region and the second system 50a is another portion of the remote system (e.g., a different portion of the same cloud computing service) located in a second geographical area or region different than the first geographical area. For example, the user 12 may desire fault tolerance for a software deployment and the system 100 may evaluate the independence of the two systems 50 to determine an effectiveness of the fault tolerance if the two systems 50 are employed. The user 12 and/or the remote system 140 may communicate with either or both systems 50 via, for example, the network 112.

The remote system 140 executes an independence evaluator 200. The independent evaluator 200 receives the independence query 20 (e.g., from the user device 10, other modules executing on the remote system 140, or other remote entities). The independence evaluator 200 also obtains a first set of time-series data 310, 310a that includes a first series of data points 312, 312a that represent a respective first system value 152, 152a and a second set of time-series data 310, 310b that includes a second series of data points 312, 312b that represents a respective second system value 152, 152b. The first system value 152a and the second system value 152b represent values similarly produced (either directly or indirectly) by the first system 50a and the second system 50a respectively.

In some examples, the system values 152 represent a duration and/or latency of requests or commands to the systems 50 or availability of various resources of the system 50. For example, the first system value 152a represents a duration of a “create virtual machine” application programming interface (API) call to the first system 50a while the second system value 152b represents a duration of the “create virtual machine” API call to the second system 50b. In other examples, the system values 152 represent latencies in providing access to a resource or in providing responses to queries. Specifically, the first system value 152a of each data point 312a of the first set of time-series data 310a may include a latency value for providing a first resource of the first system 50a while the second system value 152b of each data point 312b of the second set of time-series data 310b may include a latency value for providing a second resource of the second system 50b (where the second resource of the second system 50a is equivalent to the first resource of the first system 50a). The resources include, for example, virtual machines (VMs) executing within the systems 50a, processing capabilities, storage, etc.

Notably, implementations herein do not rely on any specific examples of system values 152. That is, the sets of time-series data 310 may include data points 312 that represent any measurable system values 152 of the systems 50 as long as the system values 152 can provide suitably dense quantities of data (e.g., multiple records per second, minute, hour, etc.) and that the system value 152 for each system 50 are directly comparable (i.e., the system value 152 for each system 50 represents the same or similar measurement for each system 50).

The independence evaluator 200 may obtain the sets of time-series data 310 by receiving periodic system values 152 that form the data points 312) from the systems 50. The independence evaluator 200 may query the systems 50 for the system values 152. The systems 50 may automatically provide the system values 152 to the independence evaluator 200. In some examples, another module collects and/or processes the data and provides the sets of time-series data 310 to the independence evaluator 200. The independence evaluator 200 may obtain the time-series data 310 prior to receiving the query 20 or in response to receiving the query 20. That is, the time-series data 310 may be recorded or gathered or otherwise collected in preparation for receiving a query 20 in the future or in response to receiving the query 20.

The independence evaluator 200 determines an amount of correlation 162 between the first set of time-series data 310a and the second set of time-series data 310b The independent evaluator 200 may generate a report 170 indicative of the amount of correlation 162. The amount of correlation 162 represents a statistical analysis defining a degree to which the first system values 152a of the first set of time-series data 310a move in coordination with the second system values 152b of the second set of time-series data 310b. In some implementations, when the amount of correlation 162 between the first set of time-series data 310a and the second set of time-series data 310b satisfies a correlation threshold 164, the independent evaluator 200 reports that the first system 50a and the second system 56b are independent. Conversely, when the amount of correlation 162 between the first system 50a and the second system 50b fails to satisfy the correlation threshold 164, the independence evaluator 200 may report that the first system 50a and the second system 50b are not independent. The correlation threshold 164 may be configurable (e.g., based on resiliency requirements of the user 12). Optionally, the independence query 20 includes the correlation threshold 164. For example, the user 12 selects a high correlation threshold 164 when resiliency or fault tolerance requirements are relatively low (i.e., a significant amount of the correlation must be determined between the systems 50 before reporting a lack of independence). In other examples, the user 12 selects a relatively lower correlation threshold 164 when resilience requirements are less stringent. The report 170 may include the amount of correlation 162, the time-series data 310, or any relevant information (e.g., histograms of the amount of correlation 162). The independence evaluator 200 may transmit the report to the user device 10 or any other entity associated with the independence query 20.

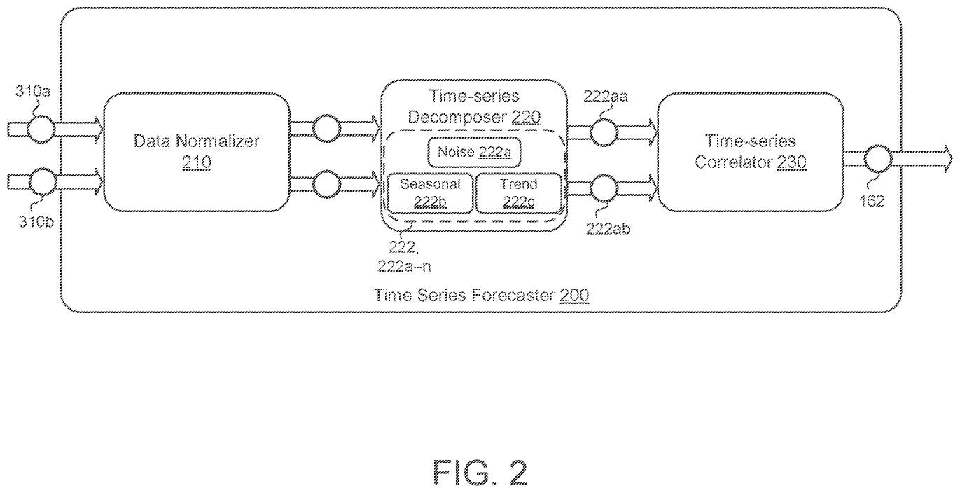

Referring now to FIG. 2, in some implementations, the independence evaluator 200 includes a data normalizer 210. The data normalizer 210 receives the sets of time-series data 310a, 310b and normalizes the first set of time-series data 310a and the second set of time-series data 310b. For example, the data normalizer 210 maps the system values 152 of each data point 312 into real numbers within a defined range (e.g., [0, 1]. In some implementations, the independence evaluator 200 additionally or alternatively includes a time-series decomposer 220. In some scenarios, different systems 50 are correlated for non-system reasons such as systems 50 within the same time zone experiencing similar fluctuations in load that may undesirably increase the amount of correlation 162 between the sets of time-series data 310. The time-series decomposer 220 decomposes both the first set of time-series data 310a and the second set of time-series data 310b into a first plurality or set of components 222, 222a-n and a second set of components 222 respectively. For example, the components 222 include a noise component 222a, a seasonal component 222b, and a trend component 222c, although other components 222 are also contemplated. In this example, the time-series decomposer 220 may drop or discard the seasonal component 222b and the trend component 222c and only retain the noise component 222a as both the seasonal component 222b and the trend component 222c may introduce unwanted inflation of the amount of correlation 162 between the sets of time-series data 310. As used herein, the noise component 222a refers to the changes in the time-series data 310 not applicable to trends or seasonal changes. The time-series decomposer 220 provides a first noise component 222aa representing the noise of the first set of time-series data 310a and a second noise component 222ab representing the noise of the second set of time-series data 310b to a time-series correlator 230.

The time-series correlator 230, in some implementations, compares a component 222 of the first set of time-series data 310a (e.g., the first noise component 222aa) and a component 222 of the second set of time-series data 310b (e.g., the second noise component 222ab). Based on this comparison, the time-series correlator 230 determines the amount of correlation 162 between the first set of time-series data 310a and the second set of time-series data 310b. In some examples, the time-series correlator 230 determines a correlation coefficient for each pair of data points 312a, 312b in the sets of time-series data 310a, 310b. The time-series correlator 230, in some of these implementations, creates, using the correlation coefficients, a correlation matrix and averages a portion of the correlation coefficients of the correlation matrix to determine the amount of correlation 162 between the first set of time-series data 310a and the second set of time-series data 310b.

Referring now to FIG. 3A, a plot 300a includes an exemplary first set of time-series data 310a and an exemplary second set of time-series data 310b. Each set of time-series data 310a, 310b includes a respective set of data points 312a, 312h plotted in time order along the x-axis. The y-axis of each data point 312a, 312 represents a corresponding value of the system value 152a, 152b. Here, for illustration purposes, a data point 312a, 312b exists at the same point in time for each set of time-series data 310a, 310b. While this is the ideal case, it is not necessary. In practice, there will often, if not always, be differences or offsets between the data points 312. Each set of time-series data 310 may have different numbers and densities of data points 312. The independence evaluator 200 may use interpolation to estimate system values 152 at points in time between collected data points 312. The system values 152 may be normalized and/or scaled for comparison.

Referring now to FIG. 3B, a plot 300b includes the first set of time-series data 310a and the second set of time-series data 310b from FIG. 3A. Here, a rolling average of the amount of correlation 162 (e.g., correlation coefficients) of the sets of time-series data 310a, 310b is included on the plot 300b. In this example, both sets of time-series data 310a, 310b include a sudden dip in value that causes a spike in the amount of correlation 162. During this spike, the amount of correlation 162 exceeds the correlation threshold 164. Thus, in this scenario, the independence evaluator 200 may report that the first system 50a represented by the first set of time-series data 310a and the second system 50b represented by the second set of time-series data 310b are not independent (i.e., because the correlation threshold 164 was exceeded). In this case, the spike in the amount of correlation 162 indicates a dependence between the two systems 50a, 50b causing a shared dip in the system values 152a, 152b measured by the sets of time-series data 310a, 310b (e.g., latencies, availability, etc.). For example, the network layer between the systems 50a, 50b is shared and a disruption to the network layer causes a slowdown in both systems 50a, 50b simultaneously, thus betraying the dependence.

Thus the independence evaluator 200 is capable of generating reports 170 to advise users 12 as to the level of independence between any two systems 50 where sufficient time-series data 310 can be gathered. This allows for the user 12 to evaluate a resiliency of products deployed across the systems 50. Moreover, the independence evaluator 200 may detect regressions in system design that introduce undesired links between systems 50 (e.g., geographically separated systems 50). In some implementations, the independence evaluator 200 provides insight into specific time periods to determine previously unknown system dependencies. For example, when the independence evaluator 200 indicates that the correlation threshold 164 was exceeded during a specific time period, detailed logs pertaining to just that specific time period may be analyzed to determine a specific cause of the dependence. The independence evaluator 200 is a black box module and thus may evaluate any two systems 50, even systems 50 operated by different providers.

Examples herein show the independence evaluator 200 determining the independence of two systems 50 based on the amount of correlation 162 between two sets of time-series data 310. However, the independence evaluator 200 may use additional sets of time-series data 310 to enhance or refine the evaluation. For example, the independence evaluator 200 determines the amount of correlation 162 for several different sets of time-series data 310 and aggregates the amounts of correlation 162 (e.g., via averaging, weighted averaging, summing, etc.) to determine a total amount of correlation or independence between the systems 50. Each set of time-series data 310 may reflect different system values 152.

In some examples, the independence evaluator 200 determines the independence of three or more systems 50 based on the amount of correlation 162 between each other system 50. The independence evaluator 200, using the amount of correlation 162 between systems 50, determines which systems 50 (or pairs of systems 50) require further or more detailed investigation. That is, the independence evaluator 200 may, based on the comparison of many different systems 50, produce an aggregate picture for the many different systems 50 to guide further investigation.

FIG. 4 is a flowchart of an exemplary arrangement of operations for a method 400 of a computer-implemented method 400 for determining an independence of systems that when executed by data processing hardware 144 causes the data processing hardware 144 to perform operations. The method 400, at operation 402, includes receiving a system independence query 20 requesting the data processing hardware 144 to determine a level of independence between a first system 50a and a second system 50b. At operation 404, the method 400 includes obtaining a first set of time-series data 310a including a first series of data points 312a listed in time order. Each data point 312a of the first series of data points 312a represents a respective first system value 152a of a feature associated with the first system 50a The method 400, at operation 406 includes obtaining a second set of time-series data 310b including a second series of data points 312b listed in time order. Each data point 312b of the second series of data points 312b represents a respective second system value 152b of the feature associated with the second system 50b. At operation 408, the method 400 includes determining an amount of correlation 162 between the first set of time-series data 310a and the second set of time-series data 310b When the amount of correlation 162 between the first set of time-series data 310a and the second set of time-series data 310b satisfies a correlation threshold 164, the method 400, at operation 410, includes reporting that the first system 50a and the second system 50b are independent.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server hank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory CEEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage devices 30 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic anchor optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an PGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g, magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EE PROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback, and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising
receiving a system independence query that requests the data processing hardware to determine a level of independence between a first system and a second system,
obtaining a first set of time-series data comprising a first series of data points listed in time order, each data point of the first series of data points representing a respective first system value of a feature associated with the first system;
obtaining a second set of time-series data comprising a second series of data points listed in time order, each data point of the second series of data points representing a respective second system value of the feature associated with the second system;
determining an amount of correlation between the first set of time-series data and the second set of time-series data; and
when the amount of correlation between the first set of time-series data and the second set of time-series data satisfies a correlation threshold, reporting that the first system and the second system are independent.

2. The method of claim 1, wherein:
the respective first system value of each data point of the first series of data points comprises a first system latency value for providing a first resource of the first system; and
the respective second system value of each data point of the second series of data points comprises a second system latency value for providing a second resource of the second system.

3. The method of claim 2, wherein:
the first resource comprises virtual machines executing within the first system; and
the second resource comprises virtual machines executing within the second system.

4. The method of claim 1, wherein the first system is located within a first geographical region and the second system is located within a second geographical region.

5. The method of claim 1, wherein determining the amount of correlation between the first set of time-series data and the second set of time-series data comprises normalizing the first set of time-series data and the second set of time-series data.

6. The method of claim 1, wherein determining the amount of correlation between the first set of time-series data and the second set of time-series data comprises:
decomposing the first set of time-series data into a first plurality of components;
decomposing the second set of time-series data into a second plurality of components; and
comparing a first component of the first plurality of components with a second component of the second plurality of the components.

7. The method of claim 6, wherein:
the first component comprises a noise component of the first set of time-series data; and
the second component comprises the noise component of the second set of time-series data.

8. The method of claim 1, wherein:
the first system is part of a cloud computing service; and
the second system is part of the cloud computing service.

9. The method of claim 1, wherein determining the amount of correlation between the first set of time-series data and the second set of time-series data comprises determining a correlation coefficient for each pair of data points of the first series of data points and the second series of data points.

10. The method of claim 9, wherein determining the amount of correlation between the first set of time-series data and the second set of time-series data further comprises:
creating, using the correlation coefficient of each pair of data points of the first series of data points and the second series of data points, a correlation matrix; and
averaging a portion of the correlation coefficients of the correlation matrix.

11. A system comprising:
data processing hardware; and
memory hardware in communication with the data processing hardware, the memory hardware storing instructions that when executed on the data processing hardware cause the data processing hardware to perform operations comprising:
receiving a system independence query that requests the data processing hardware to determine a level of independence between a first system and a second system;
obtaining a first set of time-series data comprising a first series of data points listed in time order, each data point of the first series of data points representing a respective first system value of a feature associated with the first system;
obtaining a second set of time-series data comprising a second series of data points listed in time order, each data point of the second series of data points representing a respective second system value of the feature associated with the second system;
determining an amount of correlation between the first set of time-series data and the second set of time-series data; and
when the amount of correlation between the first set of time-series data and the second set of time-series data satisfies a correlation threshold, reporting that the first system and the second system are independent.

12. The system of claim 11, wherein:
the respective first system value of each data point of the first series of data points comprises a first system latency value for providing a first resource of the first system; and
the respective second system value of each data point of the second series of data points comprises a second system latency value for providing a second resource of the second system.

13. The system of claim 12, wherein:
the first resource comprises virtual machines executing within the first system; and
the second resource comprises virtual machines executing within the second system.

14. The system of claim 11, wherein the first system is located within a first geographical region and the second system is located within a second geographical region.

15. The system of claim 11, wherein determining the amount of correlation between the first set of time-series data and the second set of time-series data comprises normalizing the first set of time-series data and the second set of time-series data.

16. The system of claim 11, wherein determining the amount of correlation between the first set of time-series data and the second set of time-series data comprises:
decomposing the first set of time-series data into a first plurality of components,
decomposing the second set of time-series data into a second plurality of components, and
comparing a first component of the first plurality of components with a second component of the second plurality of the components.

17. The system of claim 16, wherein:
the first component comprises a noise component of the first set of time-series data; and
the second component comprises the noise component of the second set of time-series data.

18. The system of claim 11, wherein:
the first system is part of a cloud computing service; and
the second system is part of the cloud computing service.

19. The system of claim 11, wherein determining the amount of correlation between the first set of time-series data and the second set of time-series data comprises determining a correlation coefficient for each pair of data points of the first series of data points and the second series of data points.

20. The system of claim 19, wherein determining the amount of correlation between the first set of time-series data and the second set of time-series data further comprises:
creating, using the correlation coefficient of each pair of data points of the first series of data points and the second series of data points, a correlation matrix, and
averaging a portion of the correlation coefficients of the correlation matrix.
